(19) United States
(12) Patent Application Publication
(10) Pub. No.: US 2005/0245706 A1
(43) Pub. Date: Nov. 3, 2005

(54) 6-Trifluoromethyl-2 vinyloxy-4-oxatricyclo[4.2.1.03,7]noname-5-one, and polymer compound

(76) Inventors: Hiroshi Koyama, HYOGO (JP); Kiyoharu Tsutsumi, Himeji-shi Hyogo (JP)

Correspondence Address: BIRCH STEWART KOLASCH & BIRCH, PO BOX 747, FALLS CHURCH, VA, 22040-0747, US

(21) Appl. No.: 10/522,062

(22) PCT Filed: Jun. 17, 2004
(86) PCT No.: PCT/JP04/08849

§ 371 Date: Jan. 21, 2005

(30) Foreign Application Priority Data
Jul. 7, 2003 (JP) 2003-271352

(51) Int. Cl. C08F 12/20

(52) U.S. Cl. 526/242; 549/262

(57) ABSTRACT

6-trifluoromethyl-2-vinyloxy-4-oxatricyclo[4.2.1.0^{3,7}]nonan-5-one of the present invention is represented by the following formula (1).

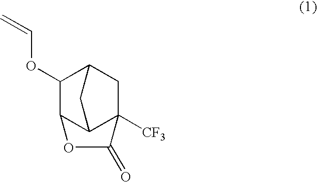

This compound can be produced by reacting 6-trifluoromethyl-2-hydroxy-4-oxatricyclo[4.2.1.0^{3,7}]nonan-5-one represented by the following formula (2) 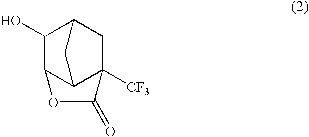
with a compound represented by the following formula (3a) or (3b), 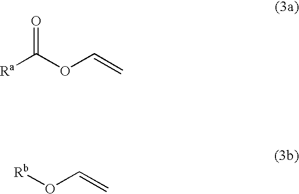
wherein R^{a} and R^{b} are each a hydrogen atom or a hydrocarbon group.

### TECHNICAL FIELD

The present invention relates to a 6-trifluoromethyl-2-vinyloxy-4-oxatricyclo[4.2.1.0^{3,7}]nonan-5-one that is useful for a monomer component of a photoresist resin used in fine patterning of semiconductors, and to a production process thereof and a polymeric compound containing a repeated unit corresponding to the compound.

### BACKGROUND ART

An exposure-light source of lithography used in semiconductor manufacture becomes shorter wavelength year after year and is converted from KrF excimer laser with a wavelength of 248 nm to ArF excimer laser with a wavelength of 193 nm. F₂ excimer laser with awavelength of 157 nm is hopefully focused as an exposure-light source of next generation. A conventional resin used in a resist for KrF excimer laser exposure or for ArF excimer laser exposure doesn't show sufficient transparency to a vacuum ultraviolet light (a light with a wavelength of 190 nm or low). Some polymeric compounds having a fluorine atom in the molecule has been proposed as a resin with a high transparency to such a vacuum ultraviolet light (for example, Japanese Unexamined Patent Application Publication No. 2002-6501, Japanese Unexamined Patent Application Publication No. 2002-155118, Japanese Unexamined Patent Application Publication No. 2002-179731, Japanese Unexamined Patent Application Publication No. 2002-220419, Japanese Unexamined Patent Application Publication No. 2002-293840, Japanese Unexamined Patent Application Publication No. 2002-327013, Japanese Unexamined Patent Application Publication No.2003-2925 and soon). However even those resins are not necessarily sufficient for permeability (transparency) to a vacuum ultraviolet light.

Further, a resin which, in addition to transparency for light used to exposure, has appropriateness such as adhesion to substrate (substrate adhesion), a property changing parts irradiated by light exposure to alkali-soluble by acid (acid-elimination function), resistance to dry etching (etching resistance) and solubility (hydrophilicity) for resist solvent or alkali developer in balance rarely exists.

### DISCLOSURE OF INVENTION

An object of the present invention is to provide a novel polymerizable monomer having a lactone ring which is useful for obtaining a polymeric compound which has excellent substrate adhesion and high permeability to a light with a wavelength of 300 nm or low, particularly F₂ excimer laser (157 nm) and other ultraviolet light, and a producing process thereof.

Anther object of the present invention is to provide a novel polymerizable monomer having a lactone ring which gives excellent substrate adhesion and high transparency to a polymer and can be easily co-polymerized with the other monomer to give various functions required as photoresists, and a producing process thereof.

A further object of the present invention is to provide a polymeric compound which is excellent for substrate adhesion and is high transparency to light with a wavelength of 300 nm or low, particularly vacuum ultraviolet light.

Another object of the present invention is to provide a polymeric compound which has high transparency to light used for exposure and has various properties such as acid-elimination function, etching resistance and substrate adhesion in balance.

The present inventors made intensive investigations to achieve the above objects and found a novel polymerizable monomer having a lactone ring skeleton and that by subjecting this monomer to polymerization, a polymeric compound which is excellent for substrate adhesion and is high transparency to a light having wavelength of 300 nm or low, particularly vacuum ultraviolet light can be obtained, and in addition, found that by a co-polymerization with the other monomer, a polymeric compound having various functions such as transparency to light used for exposure, substrate adhesion, acid-elimination function and etching resistance in balance can be obtained. The present invention was achieved based on these discoveries.

Namely, the present invention provides a 6-trifluoromethyl-2-vinyloxy-4-oxatricyclo[4.2.1.0^{3,7}]nonan-5-one represented by the following formula (1).

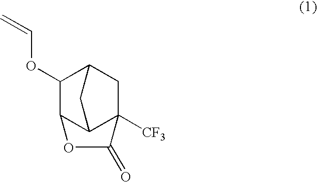

Further, the present invention provides a process for producing a 6-trifluoromethyl-2-vinyloxy-4-oxatricyclo[4.2.1.0^{3,7}]nonan-5-one represented by the following formula (1) 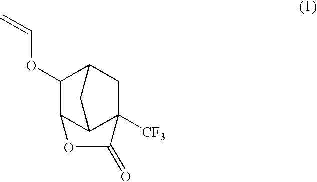
, comprising the step of reacting a 6-trifluoromethyl-2-hydroxy-4-oxatricyclo[4.2.1.0^{3,7}]nonan-5-one represented by the following formula (2) 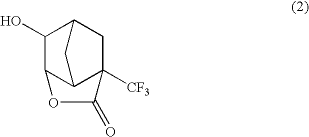
with a compound represented by the following formula (3a) or 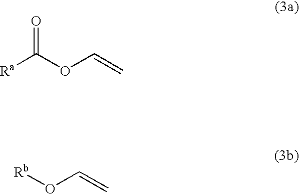
wherein R^{a} and R^{b} are each a hydrogen atom or a hydrocarbon group to obtain the 6-trifluoromethyl-2-vinyloxy-4-oxatricyclo[4.2.1.0^{3,7}]nonan-5-one.

In addition, the present invention provides a polymeric compound having a repeated unit corresponding to the 6-trifluoromethyl-2-vinyloxy-4-oxatricyclo[4.2.1.0^{3,7}]nonan-5-one.

The polymeric compound may contain further the repeated unit having acid-elimination function.

The present invention can provide a novel polymerizable monomer having a lactone ring useful for obtaining a polymeric compound which is excellent for substrate adhesion and is high permeability to light having wavelength of 300 nm or low, particularly vacuum ultraviolet light such as F₂ excimer laser (157 nm). The present invention can further provide a novel polymerizable monomer having a lactone ring which can give excellent substrate adhesion and high transparency to a polymer and can be easily co-polymerized with the other monomer to give various functions required as photoresists.

The polymeric compound of the present invention exhibits excellent substrate adhesion and high transparency to light having wavelength of 300 nm or less, particularly vacuum ultraviolet light. The compound can further give transparency to light used for exposure, hydrophilicity, acid-elimination function, etching resistance and substrate adhesion and other various functions in balance. Therefore, micro patterns can be formed in high accuracy when using the said polymeric compound as photoresist resin,.

### BEST MODE FOR CARRYING OUT THE INVENTION

### [6-trifluoromethyl-2-vinyloxy-4-oxatricyclo[4.2.1.0^{3,7}]nonan-5-one]

6-trifluoromethyl-2-vinyloxy-4-oxatricyclo[4.2.1.0^{3,7}]nonan-5-one of the present invention is shown by the above formula (1). This monomer provides a polymeric compound by polymerizing at a vinyl portion. This monomer can give substrate adhesion to a polymer because of it having a lactone skeleton. In addition, it has a trifluoromethyl group at a α position of a —COO— group of lactone, so that high transparency to light having wavelength of 300 nm or less, particularly vacuum ultraviolet light, can be given to a polymer. Further, this monomer is easy to co-polymerize with kinds of monomers, for example, the other vinyl ether monomer, an acrylic acid ester monomer and others, which is used to give various functions required as a photoresist (for example, transparency, acid-elimination function, substrate adhesion, hydrophilicity, etching resistance and so on). Therefore, a polymeric compound, which is excellent for transparency to light such as a vacuum ultraviolet light, and have acid-elimination function, substrate adhesion, hydrophilicity and etching resistance and other functions in balance, can be easily prepared.

6-trifluoromethyl-2-vinyloxy-4-oxatricyclo[4.2.1.0^{3,7}]nonan-5-one represented by the formula (1) can be obtained by reacting a 6-trifluoromethyl-2-hydroxy-4-oxatricyclo[4.2.1.0^{3,7}]nonan-5-one represented by the above formula (2) with a compound represented by the above formula (3a) or (3b). In the formulae, each of R^{a} and R^{b} is a hydrogen atom or a hydrocarbon group. As a hydrocarbon group in R^{a} and R^{b}, there may be mentioned, for example, an alkyl group such as methyl, ethyl, propyl, butyl, isobutyl, s-butyl, t-butyl, pentyl and hexyl (preferably alkyl groups each having about 1 to 10 carbon atoms); an alkenyl group such as allyl group (preferably alkenyl groups each having about 2 to 10 carbon atoms); a cycloalkyl group such as cyclohexyl group; an aryl group such as phenyl group; an aralkyl group such as benzyl group, and so on. As R^{a} and R^{b}, an alkyl group each having 1 to 3 carbon atoms such as methyl group and phenyl group are particularly preferable.

A reaction of a compound represented by the formula (2) with a compound represented by the formula (3a) is performed in the presence of a metal compound catalyst such as an iridium compound catalyst. The iridium compound catalyst is not particularly limited, and an iridium complex is preferable. Specifically, an organic iridium complex, which have an unsaturated hydrocarbon such as cyclopentene, dicyclopentadiene, cyclooctene, 1,5-cyclooctadiene, ethylene, pentamethylcyclopentadiene, benzene and toluene; a nitrile such acetonitrile; an ether such as tetrahydrofuran; and others; as a ligand are used preferably. Typical examples of the organic iridium complex are di-μ-chlorotetraxis(cyclooctene) II iridium(I), di-μ-chlorotetraxis(ethylene) II iridium(I), di-μ-chlorobis(1,5-cyclooctadiene) II iridium(I), bis(1,5-cyclooctadiene) iridium tetrafluoroborate, (1,5-cyclooctadiene) (acetonitrile) iridium tetrafluoroborate and so on. The amount of catalyst is, for example, 0.0001 to 1 mole, preferably about 0.001 to 0.3 mole, relative to 1 mole of a hydroxy compound represented by the formula (2).

In the above reaction, by existing a base in the reaction system the reaction rate is increased extremely. The base includes an inorganic base and an organic base. As the inorganic base, there may be mentioned, for example, an alkaline metal hydroxide such as sodium hydroxide, an alkaline earth metal hydroxide such as magnesium hydroxide, an alkaline metal carbonate such as sodium carbonate, an alkaline earth metal carbonate such as magnesium carbonate, an alkaline metal bicarbonate such as sodium bicarbonate and so on. As the organic salt, there may be mentioned, for example, an alkaline metal organic acid salt such as sodium acetate, an alkaline metal alkoxide such as sodium methoxide, a tertiary amine such as triethyl amine, a nitrogen-containing aromatic heterocyclic compound such as pyridine and so on. An used amount of base is, for example, 0.001 to 3 moles based on 1 mole of a compound represented by the formula (2), preferably about 0.005 to 2 moles.

A reaction (an ether-exchange reaction) of a compound represented by the formula (2) with a compound represented by the formula (3b) is performed under a metal compound catalyst such as a palladium compound catalyst, a mercury compound catalyst and a cobalt compound catalyst. As the palladium compound catalyst, there may be mentioned, for example, a complex (a palladium complex) comprising a palladium compound such as palladium acetate and palladium chloride and a nitrogen II position ligand (1,10-phenanthroline, 2,2′-bipyridile and others), and so on. As the mercury compound catalyst, there may be, for example, a complex (a mercury complex) comprising a mercury compound such as mercury acetate and the above nitrogen II position ligand and so on. In addition, as the cobalt compound catalyst, there may be a cobalt complex such as cobalt(II) acetylacetonate (a monohydrate, a dihydrate and others) and a cobalt carbonyl, and so on. A used amount of catalyst is, for example, 0.0001 to 1 mole based on 1 mole of a compound represented by the formula (3b), preferably about 0.001 to 0.3 moles.

A reaction of a compound represented by the formula (2) with a compound represented by the formula (3a) or (3b) under a solvent or non-solvent. As a solvent, there may be mentioned, for example, an aliphatic hydrocarbon such as hexane, an alicyclic hydrocarbon such as cyclohexane, an aromatic hydrocarbon such as toluene, a halogenated hydrocarbon such as dichloromethane, a cyclic ether such as tetrahydrofuran, a ketone such as acetone, an amide such as N,N-dimethylformamide, a nitrile such as acetonitrile, and so on. An used amount of a compound represented by the formula (3a) or (3b) is usually about 0.9 to 1.3 moles based on 1 mole of a compound represented by the formula (2) and in order to increase a reaction efficiency, one in both raw materials may be used in large excess. Further, a reaction may be performed while alcohol by-produced in the reaction is distilled out. The reaction may be carried out in existence of a polymerization inhibitor. A reaction temperature can be selected in accordance with a sort of reaction component and is, for example, about −10° C. to 150° C.

The reaction product can be separated and purified by separation means such as filtration, concentration, distillation, extraction, crystallization, recrystallization and column chromatography.

[Polymeric Compound]

A polymeric compound of the present invention contains a repeated unit (a monomer unit) corresponding to 6-trifluoromethyl-2-vinyloxy-4-oxatricyclo[4.2.1.0^{3,7}]nonan-5-one represented by the above formula (1). Such a polymeric compound can be obtained by subjecting a compound represented by the above formula (1) to polymerization.

In order to provide various functions required as resist in sufficient balance, a polymeric compound of the present invention may have the other repeated unit in addition to a repeated unit corresponding to a compound represented by the above formula (1). Such the other repeated unit can be produced by co-polymerizing a polymerizable unsaturated monomer corresponding to the repeated unit with a compound represented by the formula (1). As the said other repeated unit, there may be mentioned, for example, a repeated unit improving substrate adhesion and/or hydrophilic function, a repeated unit having acid-elimination function, a repeated unit having etching resistance function, a repeated unit improving transparency and so on. Further, when preparing a polymeric compound of the present invention, a monomer used to perform co-polymerization smoothly or to unify a composition of co-polymer can be used as a co-monomer.

The repeated unit improving substrate adhesion or hydrophilic function can be introduced into a polymer by using a polymerizable unsaturated monomer having a polar group as a co-monomer. As the said polar group, there may be mentioned, for example, a hydroxyl group which may have a protective group, a carboxyl group which may have a protective group, an amino group which may have a protective group, a sulfo group which may have a protective group, a group having a lactone ring and so on. As the said protective group, one commonly used in the organic synthesis field can be used. As a polymerizable unsaturated monomer having a polar group, a conventional compound in the resist field can be applied.

A repeated unit having acid-eliminating function can be introduced to a polymer by using, for example, (1) a (meth)acrylic acid ester derivative in which a hydrocarbon having a tertiary carbon, a 2-tetrahydrofuranyl group, a 2-tetrahydropyranyl group or others are combined at the adjacent position of oxygen atom constituting the ester, (2) a (meth)acrylic acid ester derivative which have a hydrocarbon group (an alicyclic hydrocarbon group, an aliphatic hydrocarbon group, a group bonded by these groups, and others) at the adjacent position of oxygen atom constituting the ester, and the hydrocarbon group is combined with —COOR group, wherein R is a tertiary hydrocarbon group, a 2-tetrahydrofuranyl group, a 2-tetrahydropyranyl group or others, directly or via linkage group as a co-monomer. In addition, a carbon atom at the adjacent position of a tertiary carbon of tertiary hydrocarbon group in the said R needs to be combined with at least a hydrogen atom. As such a (meth)acrylic acid eater derivative, conventional compounds in the resist field can be used. As typical examples of a polymerizable unsaturated monomer which can give acid-elimination function, there may be mentioned, for example, tert-butyl 2-trifuluoromethyl acrylate, 2-tetrahydropiranyl 2-trifuluoromethyl acrylate, 2-tetrahydrofranyl 2-trifuluoromethyl acrylate and others, and (meth)acrylate corresponding to them.

As typical examples of a polymerizable unsaturated monomer which can give etching resistance function, there may be mentioned, for example, 1-adamantyl 2-trifluoromethyl acrylate, cyclohexyl 2-trifluoromethyl acrylate and others, and (meth)acrylate corresponding to them.

Further, as typical examples of a polymerizable unsaturated monomer which improves transparency toward vacuum ultraviolet light and others, there may be mentioned a polymerizable compound having a fluorine atom in the molecule.

In a polymeric compound of the present invention, a ratio of a repeated unit corresponding to a compound represented by the formula (1) isn't particularly limited and is usually 1 to 99 mole % based on all monomer units forming a polymer, preferably 5 to 95 mole %, more preferably 10 to 80 mole %, particularly about 20 to 70 mole %. A ratio of a repeated unit having acid-elimination function is, for example, 5 to 80 mole % based on all monomer units forming a polymer, preferably about 10 to 60 mole %.

When the polymeric monomer of the present invention in allowed to (co-)polymerize to obtain a polymerizable monomer, polymerization can be performed by solution polymerization, bulk polymerization, suspension polymerization, bulk-suspension polymerization and emulsion polymerization and other commonly used method used in the production of acryl polymer and others, and particularly solution polymerization is preferable. In the solution polymerization, dropwise polymerization may be applied in order to obtain homogeneous quality of polymer.

As a polymerization solvent, a conventional solvent can be used and there may be mentioned, for example, an ether (diethyl ether, glycol ethers such as propylene glycol monomethyl ether, and other linear-chain ethers, tetrahydrofuran, dioxane, and other cyclic ethers), an ester (methyl acetate, ethyl acetate, butyl acetate, ethyl lactate, a glycol ether esters such as propylene glycol monomethyl ether acetate and so on), a ketone (acetone, methyl ethyl ketone, methyl isobutyl ketone, cyclohexanone and so on), an amide (N,N-dimethylacetoamide, N,N-dimethylformamide and so on), a sulfoxide (dimethylsulfoxide and so on), an alcohol (methanol, ethanol, propanol and so on), a hydrocarbon (an aromatic hydrocarbon such as benzene, toluene and xylene, an aliphatic hydrocarbon such as hexane, an alicyclic hydrocarbon such as cyclohexane, and others), a mixed solvent thereof and so on. Further, as a polymerization initiator, a conventional polymerization initiator can be applied. A polymerization temperature can be appropriately selected, for example, in a scope of from about 30 to about 150° C.

A polymer obtained by polymerization can be purified by precipitation or reprecipitation. A solvent for precipitation or reprecipitation may be either an organic solvent or water and further a mixing solvent may be well. As an organic solvent used for precipitation or reprecipitation solvent, there may be mentioned, for example, a hydrocarbon (pentane, hexane, heptane, octane, and otheraliphatichydrocarbons; cyclohexane, methylcyclohexane, and other alicyclic hydrocarbons; benzene, toluene, xylene, and other aromatic hydrocarbons), a halogenated hydrocarbon (a halogenated aliphatic hydrocarbon such as methylene chloride, chloroform and carbon tetrachloride; a halogenated aromatic hydrocarbon such as chlorobenzene and dichlorobenzene, and so on), a nitro compound (such as nitromethane and nitroethane), a nitrile (such as acetonitrile and benzonitrile), an ether (a linear chain ether such as diethyl ether, diisopropyl ether and dimethoxyethane; a cyclic ether such as tetrahydrofuran and dioxane), a ketone (such as acetone, methyl ethyl ketone and diisobutyl ketone), an ester (such as ethyl acetate and butyl acetate), a carbonate (such as dimethyl carbonate, diethyl carbonate, ethylene carbonate and propylene carbonate), an alcohol (such as methanol, ethanol, propanol, isopropylalcohol and butanol), a carboxylic acid (such as acetic acid), a mixed solvent containing these solvent and so on.

A weight average molecular weight (Mw) of a polymeric compound is, for example, from about 1000 to about 500000, preferably from about 3000 to about 50000, and a molecular weight distribution (Mw/Mn) is, for example, from about 1.5 to about 2.5. Incidentally, the said Mn is a number average molecular weight and both Mn and Mw are in terms of polystyrene.

### [Photoresist Resin Composition and Production of Semi-Conductor]

A photoresist resin composition can be produced by mixing the above polymeric compound of the present invention with a photo-acid generator. The photoresist resin composition may contain a polymer except the said polymeric compounds within a scope where a resist function is not damaged.

As a photosensitive acid generator, a compound commonly used or conventional as effectively providing acid by the action of exposure, for example, a diazonium salt, an iodonium salt (for example, diphenyl iodo hexafluorophosphate and so on), a sulfonium salt (for example, triphenyl sulfonium hexafluoroantimonate, triphenyl sulfonium hexafluorophosphate, triphenyl sulfonium methane sulfonate and so on), a sulfonic acid ester [for example, 1-phenyl-1-(4-methylphenyl)sulfonyloxy-1-benzoylmethane, 1,2,3-trisulfonyloxymethylbenzene, 1,3-dinitro-2-(4-phenylsulfonyloxymethyl)benzene, 1-phenyl-1-(4-methylphenylsulfonyloxymethyl)-1-hydroxy-1-benzoylmethane and so on], an oxathiazol derivative, s-triazine derivative, a disulfone derivative (such as diphenyldisulfone), an imide compound, an oxime sulfonate, diazonaphtoquinone, benzoin tosylate and others can be applied. These photosensitive acid generators can be used by alone or in combination of 2 or more sorts.

The amount of photosensitive acid generator can be appropriately selected depending on strength of the acid generated by photo-exposure, a ratio of each repeated unit of the polymer and others, and for example, from about 0.1 to about 30 part by weight, preferably from about 1 to about 25 part by weight, and preferably from about 2 to about 20 part by weight, relative to 100 part by weight of the polymeric compound.

A photoresist resin composition may contain, if necessary, an alkali soluble component such as an alkali soluble resin (for example, a novolac resin, a phenol resin, an imide resin, carboxyl group-containing resin and so on), a coloring agent (for example, dyes), an organic solvent (for example, such as hydrocarbons, halogenated hydrocarbons, alcohols, esters, amides, ketones, ethers, cellosolves, carbitols, glycol ether esters, and mixed solvent of them), a basic compound (such as a hindered amine), a detergent, a anti-soluble agent, a sensitizer, a stabilizer and others.

A photoresist resin composition obtained by these procedures is coated on a base or substrate, and dried, the applied film (resist film) is exposed to light (or, further baked after exposure) to form a latent pattern, and is subsequently developed to form a fine pattern with a high degree of precision.

As a base or substrate, there may be mentioned silicon wafer, metal, plastics, glass, ceramic and so on. The photoresist resin composition can be applied using a conventional application means such as a spin coater, a dip coater, a roller coater. The applied film has a thickness of, for example, from about 0.01 to about 20 μm, and preferably from about 0.05 to about 1 μm.

Light rays with different wavelengths such as ultraviolet rays and X-rays can be used in exposure. For example, g-light, i-light, excimer laser (for example, XeCl, KrF, KrCl, ArF, ArCl, F₂, Kr₂, KrAr, Ar₂ and so on) are usually used for semiconductor resist. An exposure energy is, for example, from about 0.1 to about 1000 mJ/cm².

Light irradiation allows the photosensitive acid generator to generate an acid, and the acid allows, for example, the eliminating portion of acid-eliminating group of the said polymeric compound to leave promptly and thereby yields a carboxyl group that contributes to solubilization. Therefore, development with water or an alkaline developing solution can yield a predetermined pattern with a high degree of precision.

### EXAMPLES

The present invention will be illustrated in more detail with reference to several examples below, which is not intended to limit the scope of the invention. Figures of the right-under brackets in the structural formulae of polymers denote % by mole of the prepared monomer corresponding to the repeated unit (monomer unit). A weight average molecular weight (Mw) and a molecular weight distribution (Mw/Mn) are measured by a GPC measurement using a refractometer (RI) and tetrahydrofuran (THF) as a detector and an eluent, respectively in terms of standard polystyrene. Three columns KF-806L (commercial name) manufactured by SHOUWA DENKO Inc. are connected in series to use for GPC and the reaction is performed under the condition comprising the column temperature of 40° C., RI temperature of 40° C., and eluent flow rate of 0.8 ml/min.

### Production Example 1

To a three-necked flask equipped with a thermometer, 15.2 g (0.1 mol) of 1-adamantanol, 12.1 g (0.12 mol) of triethylamine and 200 ml of tetrahydrofuran were added, and was stirred under nitrogen gas stream while cooling on ice. To the mixture 19.0 g (0.12 mol) of 2-(trifluoromethyl)acrylic acid chloride, and was stirred for 2 hours at room temperature. After the reaction the mixture was concentrated under reduced pressure, 300 ml of pure water was added to the concentrated residue and extracted twice by 300 ml of ethyl acetate. The organic layers were united, washed by each of 300 ml of 5 weight % sodium bicarbonate aqueous solution and 300 ml of 10 weight % salt aqueous solution, dried by magnesium sulfate and concentrated under reduced pressure. By purifying the concentrated residue by silica gel column chromatography 19.7 g (0.072 mol) of 1-adamantyl 2-trifluoromethyl acrylate [=1-(2-trifluoromethyl-2-propenoyloxy)adamantane] represented by the following formula (4) was obtained.

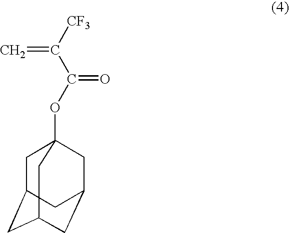

Production Example 2

By performing the same operations as the production example 1 except for using 10.0 g (0.10 mol) of cyclohexanol instead of 1-adamantanol, 17.8 g (0.080 mol) of cyclohexyl 2-trifluoromethyl acrylate [=1-(2-triufluoromethyl-2-propenoyloxy)cyclohexane] represented by the following formula (5) was obtained.

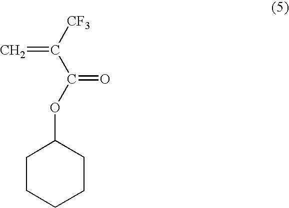

### Production Example 3

By performing the same operations as the production example 1 except for using 7.41 g (0.10 mol) of tert-butyl alcohol instead of 1-adamantanol, 10.2 g (0.052 mol) of tert-butyl 2-trifluoromethyl acrylate [=2-methyl-2-(2-triufluoromethyl-2-propenoyloxy) propane] represented by the following formula (6) was obtained.

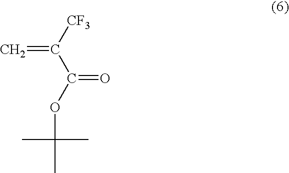

### Production Example 4

A mixed liquid of 7.0 g (50 mmol) of 2-trifluoromethyl acrylic acid, 4.2 g (50 mmol) of 3,4-dihydro-2H-pyran and 0.10 g (1 mmol) of phosphoric anhydride was stirred for 30 minutes at room temperature and then by purified by distillation under reduced pressure after passing the reaction mixture through an alumina column, 6.7 g (30 mmol) of 2-tetrahydropyranyl 2-trifluoromethyl acrylate [=2-(2-triufluoromethyl-2-propenoyloxy) tetrahydropyran] represented by the following formula (7) was obtained.

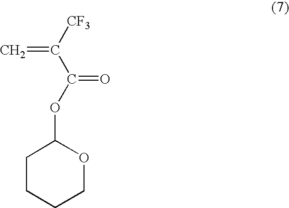

### Example 1

To a three-necked flask equipped with a Dimroth condenser, a thermometer and a dropping funnel, 90.4 g (0.438 mol) of 4-trifluoromethylbicyclo[2.2.1]hepto-6-ene-4-carboxylic acid, 8.22 g (32.9 mmol) of tungstic acid and 190.8 g of water were added, stirred at liquid temperature of 80° C. and the carboxylic acid of a raw material was dissolved. Then, 103.6 g of 15 weight % hydrogen peroxide (15.5 g of hydrogen peroxide, 0.457 mol) was dropped in over 15 minutes. The reaction mixture was stirred at 80° C. for more 4 hours. The reaction mixture was stood to cool until room temperature, 2.1 L of 10 weight % Na₂S₂O₄ aqueous solution and 280 ml of 10 weight % sodium carbonate aqueous solution added in and it was extracted twice by 1.5 L of ethyl acetate. The organic layer was washed twice by 1.5 L of 10 weight % sodium carbonate aqueous solution, dried by magnesium sulfate, and the solvent was distilled out and 65.9 g of crude product was obtained. By re-crystallizing this crude product from isopropyl ether, 35.0 g (0.158 mol) of 6-trifluoromethyl-2-hydroxy-4-oxatricyclo[4.2.1.0^{3,7}]nonan-5-one represented by the following formula (2) was obtained. In addition, 4-trifuluoromethylbicyclo[2.2.1]hepto-6-ene-4-carboxylic acid (the mixture of endo form and exo form) used as the raw material, was synthesized by Diels-Alder reaction from cyclopentadiene and 2-trifuluoromethyl acrylic acid followed to the conventional method (reference to J. Org. Chem., 56(5),1718-1725(1991) and so on) and was used.

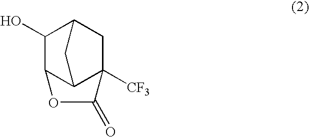

### [Spectral Data of 6-trifluoromethyl-2-hydroxy-4-oxatricyclo [4.2.1.0^{3,7}]nonan-5-one]

¹H-NMR (CDCl₃) δ: 1.83-1.89 (m, 2H), 2.14-2.24 (m, 3H), 2.53 (s, 1H), 3.38 (dd, 1H), 3.81 (s, 1H), 4.50 (d, 1H)

To a three-necked flask equipped with a Dimroth condenser, a thermometer and a dropping funnel, 4.44 g (20 mmol) of 6-trifluoromethyl-2-hydroxy-4-oxatricyclo[4.2.1.0^{3,7}]nonan-5-one, 1.27 g (12 mmol) of sodium carbonate, 134 mg (0.2 mmol) of di-μ-chlorobis(1,5-cyclooctadiene) II iridium(I) and 30 ml of toluene were added and heated at 100° C. under argon atmosphere. 4.0 g (40 mmol) of vinyl propionate was dropped into this mixture over one hour and the reaction was further performed for two hours at 100° C. This reaction mixture was stood to cool until room temperature and then the precipitates were filtrated and the filtrate was concentrated under reduced pressure. By purifying the concentrated residue due to reduced-pressure distillation, 3.26 g (13.1 mmol) of 6-trifluoromethyl-2-vinyloxy-4-oxatricyclo[4.2.1.0^{3,7}]nonan-5-one represented by the following formula (1) was obtained.

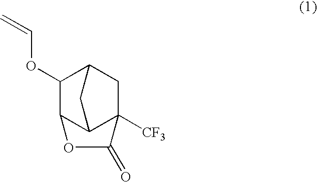

### [Spectral Data of 6-trifluoromethyl-2-vinyloxy-4-oxatricyclo [4.2.1.0^{3,7}]nonan-5-one]

¹H-NMR (CDCl₃) δ: 1.87 (d, 1H), 1.94 (dd, 1H), 2.15 (d, 1H), 2.68 (s, 1H), 3.39 (d, 1H), 3.84 (s, 1H), 4.18 (dd, 1H), 4.26 (dd 1H), 4.60 (d, 1H), 6.34 (q, 1H) MS m/e 345(M+H), 205

### Example 2

Synthesis of the polymeric compound of the following formula

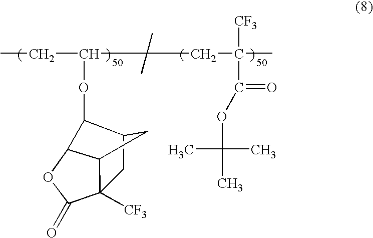

In a 100 ml round-bottom flask equipped with a reflux condenser, a stirrer and three-way cock, 5.59 g (22.5 mmol) of 6-trifluoromethyl-2-vinyloxy-4-oxatricyclo[4.2.1.0^{3,7}]nonan-5-one, 4.41 g (22.5 mmol) of 2-methyl-2-(2-trifluoromethyl-2-propenoyloxy)propane and 0.10 g of initiator [manufactured by WAKO JUNYAKU INDUSTRY Inc., trade name “V-65”] were placed and dissolved in 6.0 g of propylene glycol monomethyl ether acetate (PGMEA). Then, after the inside of flask was dried and replaced by nitrogen, the temperature of reaction system was kept at 60° C. and stirred for 3 hours under nitrogen atmosphere. The reaction mixture was diluted by 30.0 g of tetrahydrofuran, then dropped into 500 g of the mixed liquid comprising 450 g of hexane and 50 g of ethyl acetate, and the generated precipitates was filtrated. The purification was performed according to above procedure. The recovered precipitates was dried under reduced pressure, dissolved in 35 g of tetrahydrofuran, dropped into 500 g of the mixed liquid comprising 450 g of hexane and 50 g of ethyl acetate, and the generated precipitates was filtrated. The purification was repeated according to the above procedure. After drying under reduced pressure, the amount of the obtained polymer was 7.7 g. According to GPC analysis of this polymer, the weight-average molecular weight in terms of polystyrene was 7300 and the molecular-weight distribution was 2.05. Further, as result of the ¹³C-NMR (in CDCl₃) analysis, the composition ratio of polymer was 44:56 (molar ratio) (in order of the left side of the formula).

### Example 3

Synthesis of the polymeric compound of the following formula

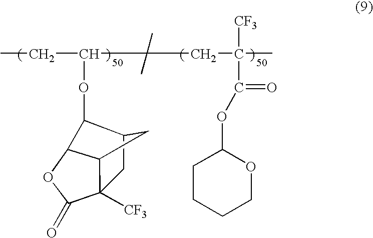

The polymeric compound was synthesized in the same manner as in Example 2 except for using 5.25 g (21.2 mmol) of 6-trifluoromethyl-2-vinyloxy-4-oxatricyclo[4.2.1.0^{3,7}]nonan-5-one and 4.75 g (21.2 mmol) of 2-(2-triufluoromethyl-2-propenoyloxy) tetrahydropyran as raw materials. After drying under reduced pressure, the amount of the obtained polymer was 7.7 g. According to GPC analysis of this polymer, the weight-average molecular weight in terms of polystyrene was 7300 and the molecular-weight distribution was 2.10. Further, as result of the ¹³C-NMR (in CDCl₃) analysis, the composition ratio of polymer was 44:56 (molar ratio) (in order of the left side of the formula).

### Example 4

Synthesis of the polymeric compound of the following formula

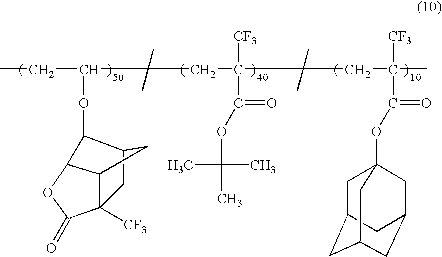

The polymeric compound was synthesized in the same manner as in Example 2 except for using 5.45 g (22.0 mmol) of 6-trifluoromethyl-2-vinyloxy-4-oxatricyclo[4.2.1.0^{3,7}]nonan-5-one, 3.45 g (17.6 mmol) of 2-methyl-2-(2-triufluoromethyl-2-propenoyloxy) propane and 1.10 g (4.4 mmol) of 1-(2-trifluoromethyl-2-propenoyloxy)adamantane as raw materials. After drying under reduced pressure, the amount of the obtained polymer was 7.1 g. According to GPC analysis of this polymer, the weight-average molecular weight in terms of polystyrene was 6800 and the molecular-weight distribution was 1.98. Further, as result of the ¹³C-NMR (in CDCl₃) analysis, the composition ratio of polymer was 45:38:17 (molar ratio) (in order of the left side of the formula).

### Example 5

Synthesis of the polymeric compound of the following formula

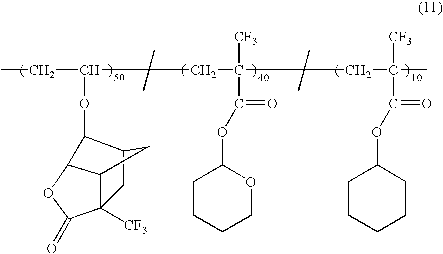

The polymeric compound was synthesized in the same manner as in Example 2 except for using 5.26 g (21.2 mmol) of 6-trifluoromethyl-2-vinyloxy-4-oxatricyclo[4.2.1.0^{3,7}]nonan-5-one, 3.80 g (17.0 mmol) of 2-(2-triufluoromethyl-2-propenoyloxy) tetrahydropyran and 0.94 g (4.2 mmol) of 1-(2-triufluoromethyl-2-propenoyloxy) cyclohexane as raw materials. After drying under reduced pressure, the amount of the obtained polymer was 6.8 g. According to GPC analysis of this polymer, the weight-average molecular weight in terms of polystyrene was 7000 and the molecular-weight distribution was 1.89. Further, as result of the ¹³C-NMR (in CDCl₃) analysis, the composition ratio of polymer was 44:42:14 (molar ratio) (in order of the left side of the formula).

Valuation Test

(Transparency of Polymer)

1 g of each of the polymers obtained in the above Examples 2 to 5 was dissolved in 10 g of propylene glycol monomethyl ether acetate (PGMEA), and was filtered through a filter of 0.2 μm to prepare a polymer solution. The polymer solution was applied onto a MgF₂ substrate by spin coating, was baked on a hot plate at a temperature of 100° C. for 120 seconds to form a polymer film 100 nm thick. Light transparency at 157 nm wavelength of the film was measured by using a vacuum-ultraviolet photometer [manufactured by NIHON BUNKO Inc., VUV-200S] and was found to be 50% or more in any case.

(Preparation of Resist and Formation of Pattern)

100 parts by weight of each of the polymers obtained in the above Example 2 to 5 and 10 parts by weight of triphenylsulfonium hexafluoroantimonate were mixed with a solvent propyleneglycol monomethyl ether acetate (PGMEA) to prepare a photoresist resin composition of 17% by weight polymer-concentration. This composition was applied onto a silicon wafer by spin coating method to form a photosensitive layer of 1.0-μm thickness. The photosensitive layer was subjected to prebaking on a hot plate at a temperature of 100° C. for 150 seconds and was exposed to light through a mask using KrF excimer laser with a wavelength of 247 nm at an irradiance of 30 mJ/cm². The exposed layer was then subjected to post-exposure baking at a temperature of 100° C. for 60 seconds; was subjected to development in a 0.3 M aqueous tetramethylammonium hydroxide solution for 60 seconds; and was rinsed with pure water to yield a pattern with a 0.20-μm line and space in any case.

1. 6-trifluoromethyl-2-vinyloxy-4-oxatricyclo[4.2.1.0^{3,7}]nonan-5-one represented by the following formula (1).

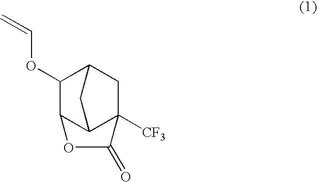

2. A process for producing a 6-trifluoromethyl-2-vinyloxy-4-oxatricyclo[4.2.1.0^{3,7}]nonan-5-one represented by the following formula (1) 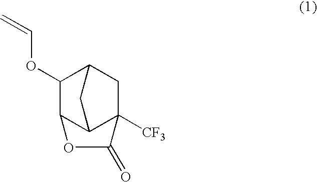
, comprising the step of reacting a 6-trifluoromethyl-2-hydroxy-4-oxatricyclo[4.2.1.0^{3,7}]nonan-5-one represented by the following formula (2) 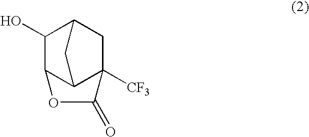
with a compound represented by the following formula (3a) or (3b), 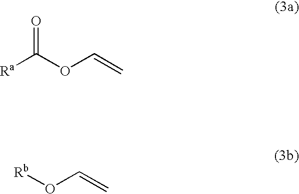
wherein R^{a} and R^{b} are each a hydrogen atom or a hydrocarbon group to obtain the 6-trifluoromethyl-2-vinyloxy-4-oxatricyclo[4.2.1.0^{3,7}]nonan-5-one.

3. A polymeric compound having a repeated unit corresponding to a 6-trifluoromethyl-2-vinyloxy-4-oxatricyclo[4.2.1.0^{3,7}]nonan-5-one of claim 1.

4. The polymeric compound according to claim 3, further having a repeated unit having acid-elimination function.
